(19) United States
(12) Patent Application Publication
(10) Pub. No.: US 2025/0068304 A1
(43) Pub. Date: Feb. 27, 2025

(54) VIRTUAL RESOURCE PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventor: Jiahuan Yang, Beijing (CN)

(21) Appl. No.: 18/811,510

(22) Filed: Aug. 21, 2024

(30) Foreign Application Priority Data
Aug. 22, 2023 (CN) 202311064461.0

(51) Int. Cl. G06F 3/0483; A63F 13/55; G06F 3/04815

(52) U.S. Cl. CPC G06F 3/0483; A63F 13/55; G06F 3/04815

(57) ABSTRACT

The present disclosure relates to a virtual resource processing method, apparatus, electronic device and storage medium. The virtual resource processing method comprises: determining, in response to a target interaction operation on a character-related content in a book, an interaction result of the target interaction operation, wherein the character-related content comprises a character discussion content and/or a character-related plot in the book; and allocating a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community. It is possible to increase the interaction fun in book reading, promote social activities and motivate users to perform more interactions of character-related contents for obtaining a wider range of character-type virtual resources.

### CROSS-REFERENCE TO RELATED APPLICATION(S)

This application claims priority to Chinese Application No. 202311064461.0 filed in Aug. 22, 2023, the disclosure of which is incorporated herein by reference in its entirety.

### FIELD

The present disclosure relates to the field of computer technology, and in particular, to a virtual resource processing method and apparatus, electronic device and storage medium.

### BACKGROUND

In current reading apps, the main functions are to recommend books to users. They read books and simply interact with books or plots in books (e.g., commenting, liking, sharing, etc.). However, these book-related functions are less interesting, and it is not easy to arouse users' reading interest and communication enthusiasm, so that the reading efficiency and reading conversion rate of books are low.

### SUMMARY

In order to solve the above technical problem, the present disclosure provides a virtual resource processing method, apparatus, electronic device and storage medium.

In a first aspect, the present disclosure provides a method of processing virtual resources, the method comprising:
determining, in response to a target interaction operation on a character-related content in a book, an interaction result of the target interaction operation, wherein the character-related content comprises a character discussion content and/or a character-related plot in the book; and
allocating a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

In a second aspect, the present disclosure provides an apparatus of processing virtual resources, the apparatus comprising:

an interaction result determining module configured to determine, in response to a target interaction operation on a character-related content in a book, an interaction result of the target interaction operation, wherein the character-related content comprises a character discussion content and/or a character-related plot in the book; and

a character-type virtual resource allocating module configured to allocate a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

In a third aspect, the present disclosure provides an electronic device, comprising:
a processor;
a memory for storing executable instructions;
wherein the processor is configured to read the executable instructions from the memory and execute the executable instructions to implement the method of processing virtual resources as described by any of the embodiments of the present disclosure.

In a fourth aspect, the present application provides a computer readable storage medium, wherein the computer readable storage medium stores computer programs which, when executed by a processor, cause the processor to implement the method of processing virtual resources as described by any of the embodiments of the present disclosure.

The virtual resource processing method, apparatus electronic device and storage medium provided by the embodiments of the present disclosure can determine, in response to a target interaction operation on a character discussion content in a book and/or a character-related plot in the book, an interaction result of the target interaction operation; and in the event that the interaction result satisfies a preset condition, allocate a character-type virtual resource to a user for user interaction in a book community; and a relationship between a plurality of character-type virtual resources is determined based on a character relationship in the book. In this way, character-type virtual resources can be distributed through the interaction of the user on the character-related content. On the one hand, the virtual resources available for interaction between users can be increased, thus enhancing the interactive fun in the process of reading books and the interactive atmosphere of the book community, and promoting the social activities of users in reading apps. On the other hand, users are motivated for more interaction of character-related contents to obtain more character-type virtual resources, thus increasing the reading conversion rate and the reading depth of users.

It is noteworthy that the user information (including, without limitation to, user device information, user personal information, etc.) and data (including, without limitation to, data for analysis, data stored, data presented, etc.) involved in the present disclosure are all information and data authorized by the user or fully authorized by all parties, and the collection, use and processing of related data should comply with corresponding laws and regulations and standards of related countries and regions, and corresponding operation entries are provided for the user to choose to authorize or reject.

### BRIEF DESCRIPTION OF THE DRAWINGS

The above and other features, advantages and aspects of the embodiments of the present disclosure will become more apparent, through the following implementations with reference to the accompanying drawings. Throughout the drawings, the same or similar reference symbols refer to the same or similar components. It would be appreciated that the drawings are provided exemplarily, where the components and elements are not necessarily drawn to scale.

FIG. 1 illustrates a flowchart of a method of processing virtual resources provided by embodiments of the present disclosure;

FIG. 2 illustrates a schematic diagram of a card of a character-type virtual resource provided by embodiments of the present disclosure;

FIG. 3 illustrates a flowchart of a method of allocating a character-type virtual resource by drawing a card in the method of processing virtual resources provided by embodiments of the present disclosure;

FIG. 4 illustrates a flowchart of a method of battling between character-type virtual resources after S120 shown in FIG. 1 provided by embodiments of the present disclosure;

FIG. 5 illustrates a flowchart of a method of allocating a skill-type virtual resource in the method of processing virtual resources provided by embodiments of the present disclosure;

FIG. 6 illustrates a schematic diagram of a structure of an apparatus of processing virtual resources provided by embodiments of the present disclosure; and

FIG. 7 illustrates a schematic diagram of a structure of an electronic device provided by embodiments of the present disclosure.

### DETAILED DESCRIPTION OF EMBODIMENTS

Reference now will be made to the drawings to describe in detail the embodiments of the present disclosure. Although the drawings show some embodiments of the present disclosure, the present disclosure can be implemented in various forms, which should not be construed as being confined to the embodiments illustrated therein. Instead, those embodiments are provided to enable those skilled in the art to understand the present disclosure more thoroughly and completely. It is to be understood that the drawings and embodiments of the present disclosure are provided only as examples, without suggesting any limitation to the protection scope of the present disclosure.

It would be appreciated that respective steps in the implementations of the method according to the present disclosure may be performed in different orders and/or performed in parallel. In addition, the method implementations may include additional steps and/or steps omitted. The scope of the present disclosure is not limited thereto.

As used herein, the term “comprise” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “at least one” by those skilled in the art, unless explicitly specified otherwise in the context.

Names of messages or information interacted between a plurality of apparatuses in the embodiments of the present disclosure are illustrative rather than limit the scope of the messages or information.

In reading apps, the main functions are to recommend books to users. They read books and simply interact with books or plots in books (e.g., commenting, liking, sharing, etc.). However, these book-related functions are less interactive and less interesting, which prevents users from discussing books in depth and reduces their motivation for reading and interaction. Further, the reading efficiency and reading conversion rate of books are low.

In view of this, the embodiments of the present disclosure provide a virtual resource processing solution so as to determine whether to allocate a character-type virtual resource related to a character in a book to a user, based on an interaction result of an interaction operation of the user on a character-related content in the book. Thus, on the one hand, it is possible to increase types of virtual resources for users' social interactions, enhance the fun of users' interactions, and motivate users for social communication; on the other hand, it is possible to motivate users to read more books in greater depth, produce derivative/interactive contents related to characters of books, and enhance the reading conversion rate and deepen the reading depth.

The virtual resource processing method provided by an embodiment of the present disclosure is applicable to a scenario in which a specific virtual resource corresponding to a character-related content in a book is allocated to a user in reading apps. The method may be performed by a virtual resource processing apparatus, which may be implemented in software and/or hardware and may be integrated in an electronic device having certain information processing power. The electronic device may include, but is not limited to, a notebook computer, a desktop computer, a server, etc.

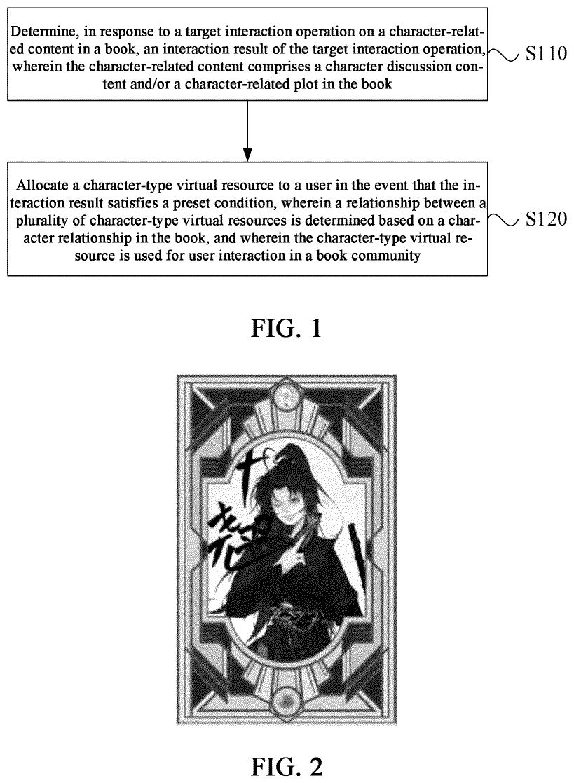

FIG. 1 shows a schematic flowchart of a virtual resource processing method provided by an embodiment of the present disclosure. As shown in FIG. 1, the virtual resource processing method may comprise:

S110, determining, in response to a target interaction operation on a character-related content in a book, an interaction result of the target interaction operation, wherein the character-related content comprises a character discussion content and/or a character-related plot in the book.

The target interaction operation is a preset interaction operation related to triggering of a virtual resource processing flow. Since the virtual resource to be allocated subsequently is a character-type virtual resource related to a character in a book, the target interaction operation may be set as an interaction operation on a character-related content in a book (referred to as a character-related content for short), so as to judge whether a character-type virtual resource can be allocated to the user performing the target interaction operation. For example, the target interaction operation may be publishing a character-related discussion content (referred to as a character discussion content for short), and also may be an interaction operation such as reading, tagging, commenting, sharing, etc., on a character-related plot in the book (referred to as a character-related plot for short). The character-related plot here may be all plots relating to the character in the book, popular/highlighted plots relating to the character, or plots relating to both the character and the main story line of the book, and so on. An interaction result is an assessment result of the interaction degree of the target interaction operation, which can be, for example, how high the quality of the character discussion content is, how much interaction there is in the character-related plot, and so on.

Specifically, with respect to a certain user, when determining whether to allocate a character-type virtual resource to the user, first, an interaction operation of the user on a character-related content in any book is obtained. If these interaction operations include a target interaction operation, it indicates that the user has triggered a basic condition for allocating the character-type virtual resource. At this point, it continues to determine an interaction result of the target interaction operation, so as to judge whether the interaction operation of the user on the character-related content is deep enough to allocate a character-type virtual resource.

In some embodiments, the character-related content comprises a character discussion content, and the target interaction operation comprises publishing a character discussion content and reading a book corresponding to the character discussion content. In this case, S110 comprises: determining, in response to a publishing operation on the character discussion content, a content quality value of the character discussion content; and determining, in response to a reading operation on the book, a reading time length.

The content quality value is used to characterize the quality of the character discussion content, which can be characterized by at least one of metrics such as the number of readers of the character discussion content, a number of interactions, and a number of reading conversions that other users are guided to read a corresponding book. The reading time length is a time length for reading the book, which may be a time length of reading once or an cumulative time length within a set time period.

Specifically, if the user publishes a character discussion content of a certain character in a book, then the electronic device may obtain a content quality value of the character discussion content. The higher the content quality value, the better the character discussion content, indicating that the user has a deeper and more precise understanding and expression of the character in the book and is more likely to be allocated with the character-type virtual resource. Meanwhile, a reading time length of the user for the book may be obtained. The longer the reading time length, the more the user likes the book, and the more likely the user will be allocated with the character-type virtual resource.

In other embodiments, the character-related content may comprise a character-related plot, at which point the target interaction operation may comprise at least one of a reading operation, a commenting operation, a tagging operation and a sharing operation on a character-related plot. In this case, S110 comprises: determining, in response to an interaction operation on the character-related plot, a number of interactions of the interaction operation.

Specifically, when the character-related content is a character-related plot, a favor degree of the user for the role may be reflected from the interaction with the character-related plot. The interaction may be reflected by a number of interactions. For example, the longer the reading time length of the user for the character-related plot, the more reading occurrences, the more comments, the higher the quality of the comments, the more plots tagged, the more plots shared and the more sharing occurrences, etc., the higher the favor degree of the user for the character, the deeper the user's understanding of the character, and the more likely that the user will be allocated with the character-type virtual resource.

S120, allocating a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

The preset condition is a preset critical condition for allocating the character-type virtual resource, which may be set based on the content of the target interaction operation and the interaction result, as well as on business requirements. The character-type virtual resource is a virtual resource related to a character, which may be, for example, cards containing character information, virtual coins matching character information, or avatars corresponding to character information, etc. With reference to FIG. 2, a character card is taken as an example of the character-type virtual resource, which is shown in the form of a card and may at least contain a character image of a corresponding character. It may be understood that the character card may further show book-related information (e.g., a book cover image or book name, etc.), other information matching the character's traits (e.g., a character ranking in the book, identity, skills, etc.), etc.

Specifically, the determined interaction result of the target interaction operation is compared with the corresponding preset condition. If the interaction result does not satisfy the preset condition, it indicates that the critical condition for allocating the character-type virtual resource to the user is not met and thus the virtual resource is not allocated. If the interaction result satisfies the preset condition, then the character-type virtual resource is allocated to the user.

Since the interaction is for the character-related content in the book described above, it that the user is interested in the character corresponding to the character-related content, so a character-type virtual resource for that character may be allocated to the user. As such, each allocated character-type virtual resource corresponds to a certain character in the book, so a plurality of character-type virtual resources corresponding to a given book are all virtual resources corresponding to respective characters in the book, and a relationship between these character-type virtual resources corresponding to a relationship between characters in the book.

The character-type virtual resources allocated above add the variety of virtual resources in reading apps, based on which a wider variety of more interesting community interaction modes may be derived. For example, character-type virtual resources may be utilized for battle interaction, boosting for relevant tasks, exchange and collection of virtual resources between a plurality of users. That is, character-type virtual resources may be used for interaction between users in a book community. Thus, the interaction fun and the community interaction atmosphere of reading apps can be enhanced, so that the user's reading motivation, interaction enthusiasm, and motivation to produce a derivative content of the book (other content such as a character discussion content generated based on the book's contents) may be increased, in order to form a positive cyclic process of interaction with character-type virtual resources—reading of the book—generation of a derivative content.

In some embodiments, when the interaction result comprises a content quality value of the character discussion content and a reading time length, the preset condition is also set as a condition corresponding to the content quality value and the reading time length, i.e., a quality threshold and a time length threshold. In this case, S120 comprises: in the event that the reading time length reaches a time length threshold and the content quality value reaches a quality threshold, allocating the character-type virtual resource of a corresponding character to the user based on the character discussion content.

The quality threshold refers to a critical value of the content quality value, which may be set based on business requirements. For example, if the content quality value is the number of readers of the character discussion content, then the quality threshold is a preset number of readers; if the content quality value is the number of interactions of the character discussion content (e.g., the number of likes, the number of shares, etc.), then the quality threshold is a preset number of interactions; if the content quality value is the number of reading conversions of the character discussion content, then the quality threshold is a preset number of reading conversions, etc. The time length threshold is a critical value of the reading time length, which may be set based on reading time lengths of a plurality of users and business requirements.

Specifically, the reading time length and the time length threshold, the content quality value and the quality threshold are compared, respectively. If at least one of them does not reach the corresponding threshold, it is considered that the interaction result does not meet the preset condition, and the character-type virtual resource is not allocated. If both of them reach the corresponding thresholds, it is considered that the interaction result meets the preset condition, and the character-type virtual resource for the character discussed in the character discussion content is allocated to the user. Thus, in order to obtain more character-type virtual resources, the user may be motivated to read the book in depth and actively publish relevant high-quality character discussion contents, promoting the generation of derivative contents for the book. Further, the reading depth of the book is increased, and the reading conversion rate of the book is boosted.

In some embodiments, besides being used for user interaction in the book community, the character-type virtual resource can further be shown at user or book related information to increase the user or book related information content, and can be further used to exchange for other virtual resource, etc. That is, the virtual resource processing method may further present relevant information of the character-type virtual resource by at least one of A to C as follows:

A. presenting, in a first page, a total number of the character-type virtual resources corresponding to the book.

The first page is a page for presenting information about the book, which may be, for example, a details page of the book, a reader ranking page corresponding to the book and so on.

Specifically, with respect to a book, the more character-type virtual resources collected by readers, the more readers read and interact with the book, reflecting relatively high popularity and quality of the book to some extent. Therefore, a total cumulative number of the character-type virtual resources corresponding to the book collected by readers may be presented in some form at a proper location of the first page as a recommendation reason for the book, helping more readers to make decisions on choosing the book and further improving the recommendation success rate and reading conversion rate of the book.

It is noteworthy that both the presentation form and presentation location of the total number of the character-type virtual resources may be set to be compatible with existing book information, so as to add recommendation reasons for the book without reducing the original book information.

B. presenting a first resource identifier of the character-type virtual resource in an information presenting area of the user in a second page.

The second page is a presentation page related to the user, for example, may be a page where the book community or book circle is located, a comment section page corresponding to the book, etc. The first resource identification is identification information of the character-type virtual resource, for example, may be a picture, a name, etc. of the character-type virtual resource. A content and display style of the first resource identification may be determined based on a number of character-type virtual resources, the size of an area of the display location, etc.

Specifically, if a certain user collects more character-type virtual resources for a particular book, it means that the more the user likes the book, the more in-depth and thorough the user's understanding of the book's content, the more attention the user's recommendation of the book deserves, and the higher the book conversion rate corresponding to a derivative content of the user. Therefore, the character-type virtual resource may also be presented in a page related to the user as a reading honour for the user, to illustrate the user's credentials with respect to the book. In this way, it is possible to promote users' motivation to collect character-type virtual resources to a certain extent, and further enhance their motivation in book reading, generation of book-derived contents and community interaction.

C. in the event that the cumulative number of the character-type virtual resources reaches a preset number or a character type of the character-type virtual resources reaches a preset type, converting the respective character-type virtual resources to a first preset resource.

The preset number and the preset type are a preset number critical value and a preset character type critical value for character-type virtual resources respectively. The first preset resource is a preset, other type of virtual resource that can be exchanged for a character-type virtual resource, which may be at least one of, for example, a physical book, an author's signature, virtual coins, side-line range of gifts of books, and advanced permissions for a reading app (e.g., theme styles, effect gifts, etc.), and the like.

Specifically, in order to cover the resource needs of a wider range of users, the character-type virtual resource can also be set to be exchanged for the first preset resource provided by a reading app. In this case, the cumulative number of the character-type virtual resources needs to reach the preset number, or a character type of the character-type virtual resources needs to reach the present type.

The virtual resource processing method provided by the various embodiments of the present disclosure can determine, in response to a target interaction operation on a character discussion content in a book and/or a character-related plot in the book, an interaction result of the target interaction operation; and in the event that the interaction result satisfies a preset condition, allocate a character-type virtual resource to a user for user interaction in a book community; and a relationship between a plurality of character-type virtual resources is determined based on a character relationship in the book. In this way, character-type virtual resources can be distributed through the interaction of the user on the character-related content. On the one hand, the virtual resources available for interaction between users can be increased, thus enhancing the interactive fun in the process of reading books and the interactive atmosphere of the book community, and promoting the social activities of users in reading apps. On the other hand, users are motivated for more interaction of character-related contents to obtain more character-type virtual resources, thus increasing the reading conversion rate and the reading depth of users.

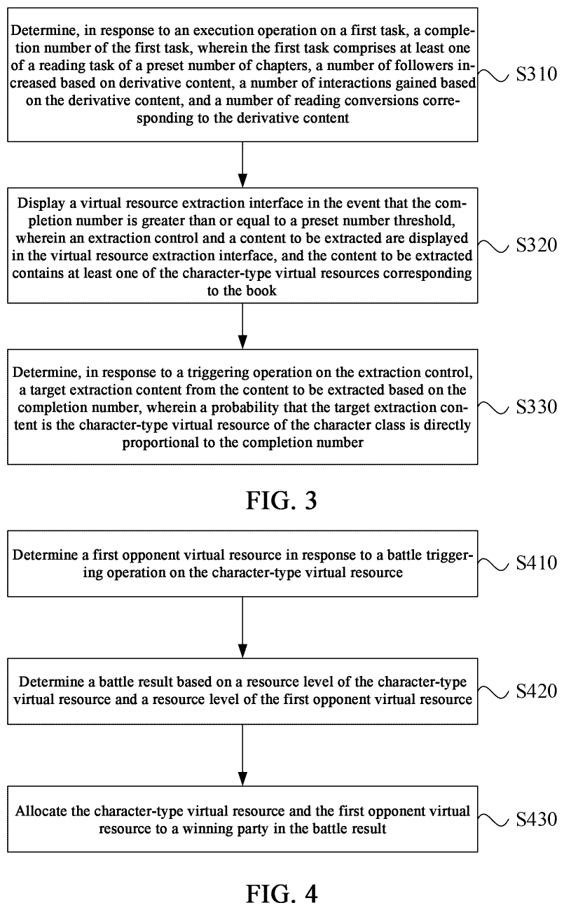

In some embodiments, for users who hesitate to publish character discussion contents or the quality of character discussion contents published by whom is not high enough but who like to read other type of interaction, in order to draw them to the interaction of character-type virtual resources, enhance their social motivation and guide them to read deeper into books and engage in more social interactions, the virtual resource processing method may further allocate a character-type virtual resource to a user through random card drawing. With reference to FIG. 3, the virtual resource processing method specifically comprises the following:

S310, in response to an execution operation on a first task, a completion number of the first task is determined, wherein the first task comprises at least one of a reading task of a preset number of chapters, a number of followers increased based on derivative content, a number of interactions gained based on the derivative content, and a number of reading conversions corresponding to the derivative content.

The first task is a preset interaction task for a book-related content (e.g., a book content, a derivative content of the book, etc.). In the embodiments of the present disclosure, the first task may be a reading task of a preset number of chapters, which may be determined based on the number of chapters read at least by a plurality of users interested in the book; the first task may further be the number of followers of a user increased after interacting (e.g., reading, sharing, etc.) with the derivative content of the book published by the user, i.e., the number of followers increased by interacting with the derivative content published by the user; the first task may further be a number of interactions (e.g., number of likes, number of comments, etc.) that other users interact with the derivative content published by the user; the first task may further be a number of users reading a corresponding book after reading the derivative content published by the user, i.e., a number of reading conversions corresponding to the derivative content.

Specifically, according to the foregoing description, the user might enjoy reading and/or engaging in interactive operations of generating and publishing non-derivative contents. For these users, there may be no corresponding target interaction operation, or the interaction result of the target interaction operation fails to meet the preset condition. Therefore, in this embodiment, the at least one first task may be preset, and a number of first tasks completed by the user (i.e., completions number) may be detected. The larger the number of first tasks completed by the user, the higher the possibility of the user engaging in social interaction, and the higher the degree of the user interested in character-type virtual resources.

S320, a virtual resource extraction interface is displayed in the event that the completion number is greater than or equal to a preset number threshold, wherein an extraction control and a content to be extracted are displayed in the virtual resource extraction interface, and the content to be extracted contains at least one of the character-type virtual resources corresponding to the book.

The preset number threshold is a preset, minimum value of the number of first tasks being completed, which may be set based on the level of promotion of character-type virtual resources. For example, the higher of the level of promotion, the less the preset number threshold. As an example, the preset number threshold is a positive integer that is at least greater than or equal to 1.

Specifically, if the completion number of first tasks completed by the user is greater than or equal to the preset number threshold, it indicates that the user has triggered a random card draw for obtaining character-type virtual resources. At this point, a virtual resource extraction interface may be presented to the user, and an extraction control (e.g., a button or gesture prompt, etc.) and a content to be extracted are displayed in the interface. The specific content of the content to be extracted is invisible to the user during the drawing process, and the content to be extracted contains at least one of the character-type virtual resources corresponding to the book. Since the first task cannot be completely related to the character-related content in the book, the character-type virtual resources contained in the content to be extracted may be a character-type virtual resource such as a random character in the book, a character at the bottom of the character rankings, or a popular character, and so on.

S330, in response to a triggering operation on the extraction control, a target extraction content from the content to be extracted is determined based on the completion number, wherein a probability that the target extraction content is the character-type virtual resource of the character class is directly proportional to the completion number.

Specifically, if the user has performed a triggering operation on the extraction control, the electronic device may determine a probability that the character-type virtual resource in the content to be extracted is drawn, in direct proportion to the completion number of first tasks. Then, the extracted content (i.e., target extracted content) to be finally presented to the user is determined from the content to be extracted based on the probability.

It is noteworthy that for users meeting preset conditions for the content quality of the character discussion content and the reading time length, they may be allocated with character-type virtual resources by means of random card drawing as described in the above embodiments, so as to further increase the allocation efficiency of character-type virtual resources and further promote reading social activities of users.

In some embodiments, user interaction in the book community may be realized by battling against character-type virtual resources between users, so as to further enhances the fun and motivation of user interaction. With reference to FIG. 4, after S120, the virtual resource processing method further comprises the following:

S410, a first opponent virtual resource is determined in response to a battle triggering operation on the character-type virtual resource.

The first opponent virtual resource is a character-type virtual resource as a battle opponent, which may be automatically allocated by the electronic device or selected by the user.

Specifically, a battle interaction mode may be set for the character-type virtual resource. As such, the electronic device may present to the user an interaction control corresponding to the battle function, such as a battle button displayed on a page where the character-type virtual resource is located, or a battle shortcut option that pops up when the character virtual resource is triggered, etc. When the user triggers the interaction control corresponding to the battle function, the electronic device may determine the first opponent virtual resource in response to the operation.

S420, a battle result is determined based on a resource level of the character-type virtual resource and a resource level of the first opponent virtual resource.

The resource level is used for characterizing combat power of the character-type virtual resource. The higher the resource level, the stronger the combat power, and the higher the probability of winning the battle. The resource level may be determined based on the importance ranking of a character in the book, relevant description information in the book about a force value and social status of a character, or further depending on whether a character has a character combination in the book.

Specifically, after the electronic device determines at least one character-type virtual resource and at least one first opponent virtual resource selected by the user to participate in the battle, the electronic device may determine the resource levels of the character class virtual resources of the two sides. Then, a battle result of the two sides may be determined based on the resource levels of the two sides. For example, the overall resource level of the at least one character-type virtual resource of the user side is higher than that of the at least one first opponent virtual resource of the opponent side, then the battle result may be determined as the user side winning. Otherwise, the battle result may be determined as the opponent side winning.

It is noteworthy that the above overall resource level may be a simple superposition of a plurality of resource levels, or may be an exponential increase or decrease of a resource level depending on the relationship between characters (e.g., co-operation/friendship, or hostile relationship, etc.).

In some embodiments, the resource level of the character-type virtual resource may be determined by at least one of D˜H.

D, a resource level of the character-type virtual resource is determined based on a character definition in the book of a target character corresponding to the character-type virtual resource. Here the character definition may be construed as an importance ranking of the character in the book, e.g., a first leading character, a first supporting character, etc. The higher the character definition, the more important the character, and the more plots in the book. Therefore, it may be considered that the character-type virtual resource of the target character with a higher character definition has a higher resource level. For example, the resource level of the first leading actor “Bai x Hua” in TV series “The Journey of Flower” is higher than that of the second leading actor “Sha x Mo”. Thus, the resource level of the character-type virtual resource may be defined based on a relationship between characters in the book, and the association between character-type virtual resources and book contents may be enhanced, thereby further motivating users to read books in depth and driving them for more social interactions so as to obtain more important character-type virtual resources.

E. a resource level of the character-type virtual resource is determined based on whether the character-type virtual resource has a combination relationship with character-type virtual resources corresponding to other characters. An overall resource level may be determined based on a relationship in the book between respective characters corresponding to combined character-type virtual resources. For example, if respective characters corresponding to the combined character-type virtual resources are in a co-operative or friend relationship with each other, and the character definition of at least one of the characters is relative high in the book, then it may be considered that the overall resource level is in an exponential increase relationship. For example, the resource level of the first leading actor “Bai x Hua” in TV series “The Journey of Flower” is higher than that of the second leading actor “Sha x Mo”, whereas when “Sha x Mo” is combined with the first leading actress “Hua x Gu”, the resource level of “Sha x Mo” can be increased exponentially to be equal to or even higher than the resource level of “Bai x Hua”.

Furthermore, it may be further considered whether the combined character was once in a friendly relationship with an opponent character, and if so, the combined character can hold the opponent character in check to some extent, thus raising the overall resource level of the combined character even further. In the foregoing example, since “Bai x Hua” and “Hua x Gu” are once master and disciple, when “Sha x Mo” is combined with “Hua x Gu” to battle with “Bai x Hua”, the resource level of “Sha x Mo” is significantly increased to be higher than that of “Bai x Hua”. Thus, the association between the character-type virtual resource and the book content may be further enhanced, and users are motivated to read the book content in depth and complete more community interactions so as to obtain a wider range of more significant character-type virtual resources.

F, a resource level of the character-type virtual resource is determined based on character identity of the target character in the book. Here the character identity is the social status of a character in the social context defined by the book content, such as professional identity, the underworld identity, etc. If the character identity of a given character in the book is higher than that of another character, it may be considered that the resource level of the character-type virtual resource corresponding to the given character is higher than the resource level of the character-type virtual resource corresponding to the another character. For example, the character identity of a civil servant is higher than the character identity of a scholar, so the resource level of the character-type virtual resource corresponding to the civil servant is higher than the resource level of the character-type virtual resource corresponding to the scholar; for another example, two scholars have equivalent character identities, whereas one of them is superimposed with an underworld killer identity, then it may be considered that the scholar superimposed with a killer identity has a higher character identity than the other scholar, and in turn, the resource level of the character-type virtual resource corresponding to the scholar superimposed with the killer identity is higher than the resource level of the character-type virtual resource corresponding to the other scholar. Thus, it is possible to further improve the association between the character-type virtual resource and the book content.

G, a resource level of the character-type virtual resource is determined based on a number of book interactions of the user. Here the number of book interactions comprises at least one a reading time length of the book, a number of interactions of derivative content of the book, and a number of reading conversions corresponding to the derivative content published by the user. In this example, the resource level is determined based on the community interaction of the user. For the same character-type virtual resource, the greater the number of book interactions of the user in the book community, the higher the resource level of the character-type virtual resource of the user. Thus, it is possible to further motivate the user to make more community interactions and enhance the community atmosphere to some extent.

H, a resource level of the character-type virtual resource is determined based on a number of booster users with whom the user has a social relationship. In this example, the more boosts the user receives from social friends, the higher the resource level of the character-type virtual resource. Thus, it is possible to further promote social activities between users.

S430, the character-type virtual resource and the first opponent virtual resource to a winning party in the battle result are allocated.

Specifically, as a reward for the battle, the electronic device may redistribute the character-type virtual resources of the losing party involved in the battle interaction to the winning party. That is, the winning party of the battle may obtain both the first opponent virtual resource and the character-type virtual resource selected by the user to participate in the battle.

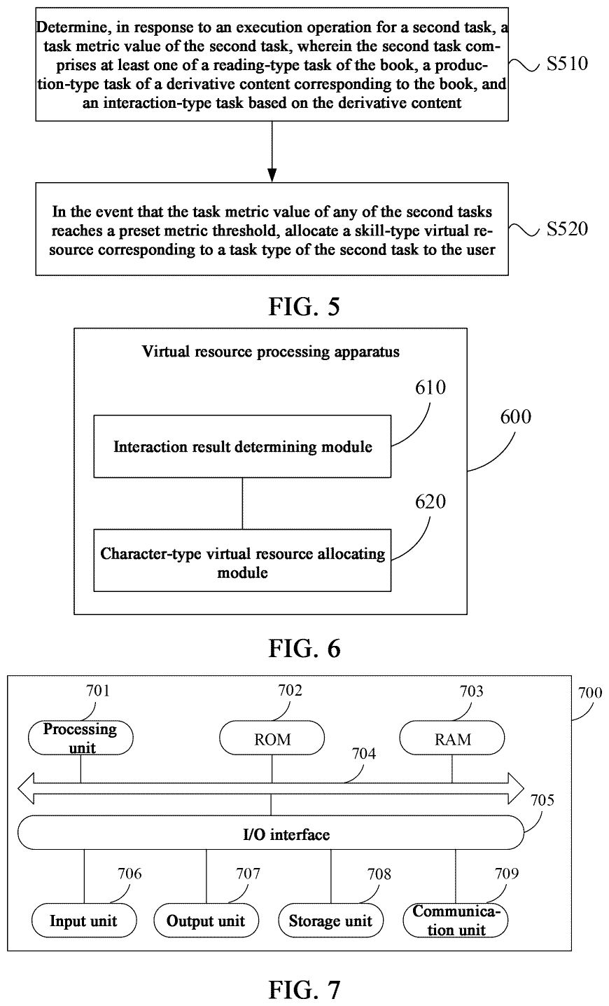

In some embodiments, the virtual resource processing method may further allocate a skill-type virtual resource to the user based on the user's interaction behavior, so as to further increase the variety of virtual resources, further enhance the interest and motivation of the user's social interaction, and thus further enhance the reading conversion rate and the reading depth of the book. With reference to FIG. 5, the virtual resource processing method may further specifically comprise the following:

S510, in response to an execution operation on a second task, a task metric value of the second task is determined; wherein the second task comprises at least one of a reading-type task of the book, a production-type task of a derivative content corresponding to the book, and an interaction-type task based on the derivative content.

The second task is a preset interaction task for a book-related content (e.g., a book content, a derivative content of the book, etc.). In the embodiments of the present disclosure, the first task may be a reading-type task, for example, to finish reading a certain type of book; the second task may further be a production-type task, for example, to produce and publish a good-quality book recommendation content, character discussion content, etc.; the second task may further be an interaction-type task, for example, newly increased followers, number of user interactions and the like brought by a published derivative content. The task metric value is a metric value for evaluating the completion of the second task. For example, when the second task is a reading-type task, the task metric value may be a number of books which have been read; when the second task is a production-type task, the task metric value may be a number of good-quality book recommendation contents or character discussion contents which have been published; when the second task is an interaction-type task, the task metric value may be a number of interactions or followers increased as a result of the derivative content.

Specifically, the electronic device may obtain a task executed by the user. If the execution task is determined as the second task, then the task metric value of the executed second task is determined, so as to judge whether to allocate a skill-type character resource to the user subsequently.

S520, in the event that the task metric value of any of the second tasks reaches a preset metric threshold, a skill-type virtual resource corresponding to a task type of the second task to the user is allocated.

The preset metric threshold is a critical value of corresponding task metric set based on a type of the second task. For example, when the second task is a reading-type task, the preset metric threshold may be a preset critical value of a number of books; when the second task is a production-type task, the preset metric threshold may be a quality threshold and a number threshold of book recommendation contents or character discussion contents; when the second task is an interaction-type task, the preset metric threshold may be a critical value of a number of interactions or increased followers.

Specifically, the electronic device, after determining that the user has executed a given second task, determines a preset metric threshold corresponding to the second task. Then, if it is determined after comparison that the obtained task metric value of the second task reaches the preset metric threshold, a skill-type virtual resource corresponding to the task type of the second task is allocated to the user. For example, if the second task is a reading-type task, then a reading-type skill-type virtual resource is allocated.

In the embodiments of the present disclosure, an attack value of the skill-type virtual resource is determined based on at least one of a reading time length of the book, a number of interactions of the derivative content, a number of reading conversions corresponding to the derivative content, a number of booster users with a social relationship. Here the attack value is a metric value for characterizing combat power of a skill-type virtual resource, which is for battling with at least one other skill-type virtual resource corresponding to the same task type. The attack value of a skill-type virtual resource may be directly proportional to the above respective interaction number. The higher the interaction number, the higher the attack value, and the higher the probability of winning the battle.

It is noteworthy that a base attack value may be set in advance for each type of skill-type virtual resource, and then the increase in the attack value determined by the above interactions can be superimposed to obtain a final attack value of a certain skill-type virtual resource.

In some embodiments, the skill-type virtual resource may also realize user interaction in the book community through battling, which further enhances the fun and motivation of user interaction. The battling process of the skill-type virtual resource may comprise: determining, in response to a battle triggering operation on at least one of the skill-type virtual resources under the same task type, at least one second opponent virtual resource under the task type; and determining a battle result based on an attack value of the skill-type virtual resource and an attack value of the second opponent virtual resource.

Specifically, since skill-type virtual resources are classified according to task types, skill-type virtual resources under the same task type perform battle interaction in a battle operation. After the user selects at least one skill-type virtual resource of the same task type for participating in the battle interaction, the electronic device may determine at least one opponent skill-type virtual resource under the task type (i.e., second opponent virtual resource) based on the task type. For example, the electronic device randomly selects a second opponent virtual resource under the task type, or selects a second opponent virtual resource based on a winning rate of the user, or provides a selection interface to the user to select a second opponent virtual resource, etc. Afterwards, a battle result is determined based on attack values of the two sides. Likewise, the winning party of the battle may obtain all skill-type virtual resources involved in the battle.

In some embodiments, the skill-type virtual resource may also be presented at relevant information of the user or book so as to increase the relevant information content of the user or book, which may also be used for exchanging other virtual resource. That is, the virtual resource processing method may further display relevant information on the skill-type virtual resource through I and/or J:

I. presenting a second resource identifier of the skill-type virtual resource of the user in a third page.

The third page is another presentation page related to the user, for example, the user's personal home page, a page in the book community that presents the derivative content published by the user, etc. The second resource identifier is identification information of the skill-type virtual resource, for example, a picture or name of the skill-type virtual resource. A content and display style of the second resource identifier may be determined based on a number of skill-type virtual resources and the area size of a display location.

Specifically, since the skill-type virtual resource is mainly related to the user's community interaction behavior and is less related to a single book, the skill-type virtual resource can be used as a general way of authenticating user influence. Therefore, the electronic device may display the second resource identifier of the skill-type virtual resource collected by the user, in a third page with larger scope of visibility to a wider range of users in order to be informed of the user's reading influence.

It is noteworthy that the second resource identifier presented in the third page may be a skill-type virtual resource selected by the user, i.e., the user may select whether to present the second resource identifier of the skill-type virtual resource, and may further select which third page displays the second resource identifier for which skill-type virtual resource.

J, additionally allocating a second preset resource to the user based on the number of wins of the user.

The second preset resource is a preset, other-type virtual resource that may be exchanged with a skill-type virtual resource, for example, at least one of virtual coins, advanced permissions for a reading app (e.g., avatar pendants, theme styles, effect gifts, etc.), side-line range of products of reading apps and the like.

Specifically, in order to cover the resource needs of more users, the skill-type virtual resource can also be set to be exchanged for the second preset resource provided by a reading app. In this case, the second preset resource which the user can exchange with the skill-type virtual resource may be determined based on the number of wins the user has won in the battle of the skill-type virtual resources. For example, the larger the number of wins, the wider the range of options and the higher the value of the second preset resources that can be exchanged.

A virtual resource processing apparatus provided by an embodiment of the present invention is described below. The apparatus belongs to the same inventive concept as the virtual resource processing method described in the above various embodiments. Therefore, for contents which are not detailed in the embodiment of the virtual resource processing apparatus, reference may be made to the above embodiments of the virtual resource processing method.

FIG. 6 shows a structural schematic diagram of a virtual resource processing apparatus provided by an embodiment of the present disclosure. As shown in FIG. 6, the virtual resource processing apparatus 600 may comprise:

an interaction result determining module 610 configured to determine, in response to a target interaction operation on a character-related content in a book, an interaction result of the target interaction operation, wherein the character-related content comprises a character discussion content and/or a character-related plot in the book; and

a character-type virtual resource allocating module 620 configured to allocate a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

The virtual resource processing apparatus provided by the embodiment of the present disclosure can determine, in response to a target interaction operation on a character discussion content in a book and/or a character-related plot in the book, an interaction result of the target interaction operation; and in the event that the interaction result satisfies a preset condition, allocate a character-type virtual resource to a user for user interaction in a book community; and a relationship between a plurality of character-type virtual resources is determined based on a character relationship in the book. In this way, character-type virtual resources can be distributed through the interaction of the user on the character-related content. On the one hand, the virtual resources available for interaction between users can be increased, thus enhancing the interactive fun in the process of reading books and the interactive atmosphere of the book community, and promoting the social activities of users in reading apps. On the other hand, users are motivated for more interaction of character-related contents to obtain more character-type virtual resources, thus increasing the reading conversion rate and the reading depth of users.

In some embodiments, the interaction result determining result 610 is specifically configured to:
determine, in response to a publishing operation on the character discussion content, a content quality value of the character discussion content; and
determine, in response to a reading operation on the book, a reading time length.

Further, the character-type virtual resource allocating module 620 is specifically configured to:

in the event that the reading time length reaches a time length threshold and the content quality value reaches a quality threshold, allocate the character-type virtual resource of a corresponding character to the user based on the character discussion content.

In other embodiments, the interaction result determining module 610 is specifically configured to:
determine, in response to an interaction operation on the character-related plot, a number of interactions of the interaction operation, wherein the interaction operation comprises at least one of a reading operation, a commenting operation, a tagging operation and a sharing operation.

In some embodiments, the virtual resource processing apparatus 600 further comprises a target extraction content determining module configured to:
determine, in response to an execution operation on a first task, a completion number of the first task, wherein the first task comprises at least one of a reading task of a preset number of chapters, a number of followers increased based on derivative content, a number of interactions gained based on the derivative content, and a number of reading conversions corresponding to the derivative content;
display a virtual resource extraction interface in the event that the completion number is greater than or equal to a preset number threshold, wherein an extraction control and a content to be extracted are displayed in the virtual resource extraction interface, and the content to be extracted contains at least one of the character-type virtual resources corresponding to the book; and
determine, in response to a triggering operation on the extraction control, a target extraction content from the content to be extracted based on the completion number, wherein a probability that the target extraction content is the character-type virtual resource of the character class is directly proportional to the completion number.

In some embodiments, a resource level of the character-type virtual resource is determined based on at least one of: a character definition in the book of a target character corresponding to the character-type virtual resource; whether the character-type virtual resource has a combination relationship with character-type virtual resources corresponding to other characters; character identity of the target character in the book; a number of book interactions of the user; and a number of booster users with whom the user has a social relationship,
wherein the number of book interactions comprises at least one of a reading time length of the book, a number of interactions of derivative content of the book, and a number of reading conversions corresponding to the derivative content published by the user.

In some embodiments, the virtual resource processing apparatus 600 further comprises a character-type virtual resource battling module configured to:
after allocating the character-type virtual resource to the user in the event that the interaction result satisfies the preset condition, determine a first opponent virtual resource in response to a battle triggering operation on the character-type virtual resource;
determine a battle result based on a resource level of the character-type virtual resource and a resource level of the first opponent virtual resource; and
allocate the character-type virtual resource and the first opponent virtual resource to a winning party in the battle result.

In some embodiments, the virtual resource processing apparatus 600 further comprises a character-type virtual resource presenting module configured to present information related to the character-type virtual resource in at least one of the following ways:
presenting, in a first page, a total number of the character-type virtual resources corresponding to the book;
presenting a first resource identifier of the character-type virtual resource in an information presenting area of the user in a second page; and
in the event that the cumulative number of the character-type virtual resources reaches a preset number or a character type of the character-type virtual resources reaches a preset type, converting the respective character-type virtual resources to a first preset resource.

In some embodiments, the virtual resource processing apparatus 600 further comprises a skill-type virtual resource allocating module configured to:
determine, in response to an execution operation on a second task, a task metric value of the second task, wherein the second task comprises at least one of a reading-type task of the book, a production-type task of a derivative content corresponding to the book, and an interaction-type task based on the derivative content; and
in the event that the task metric value of any of the second tasks reaches a preset metric threshold, allocate a skill-type virtual resource corresponding to a task type of the second task to the user, wherein an attack value of the skill-type virtual resource is determined based on at least one of a reading time length of the book; a number of interactions of the derivative content; a number of reading conversions corresponding to the derivative content; a number of booster users with a social relationship; and an attack value is for battling with at least one other skill-type virtual resource corresponding to the same task type.

Further, the virtual resource processing apparatus 600 further comprises a skill-type virtual resource presenting module configured to present information related to the skill-type virtual resource in at least one of the following ways:
presenting a second resource identifier of the skill-type virtual resource of the user in a third page; and
additionally allocating a second preset resource to the user based on the number of wins of the user.

The virtual resource processing apparatus provided by the embodiments of the present disclosure can perform the virtual resource processing method provided by any of the embodiments of the present disclosure, which includes corresponding functional modules for performing the method and has the advantageous effects.

It is noteworthy that in the foregoing embodiments of the virtual resource processing apparatus, the respective modules included are divided based on functional logic, whereas these modules are not limited to the above-described division so long as they can accomplish corresponding functions. In addition, specific names of the respective functional modules are merely for differentiation from each other, rather than limiting the protection scope of the present disclosure.

An embodiment of the present disclosure further provides an electronic device, which may comprise a processor and a memory for storing executable instructions. The processor may be configured to read the executable instructions from the memory and execute the same to implement the virtual resource processing method as described in the foregoing embodiments.

FIG. 7 illustrates a schematic diagram of a structure of an electronic device 700 provided by embodiments of the present disclosure.

As shown in FIG. 7, the electronic device 700 may include a processing unit (e.g. a central processor, a graphics processor or the like) 701, which can execute various acts and processing based on programs stored in a Read Only Memory (ROM) 702 or a program loaded from a storage unit 708 to a Random Access Memory (RAM) 703. RAM 603 stores therein various programs and data required for operations of the electronic device 700. The processing unit 701, the ROM 702 and the RAM 703 are connected to one another via a bus 704. An input/output (I/O) interface 705 is also connected to the bus 704.

Typically, the following units may be connected to the I/O interface 705: an input unit 706 including, for example, a touchscreen, a touch pad, a keyboard, a mouse, a camera, a microphone, an accelerometer, a gyroscope and the like; an output unit 707 including, for example, a Liquid Crystal Display (LCD), a loudspeaker, a vibrator and the like; a storage unit 708 including, for example, a tape, a hard drive and the like; and a communication unit 709. The communication unit 709 can allow wireless or wired communication of the electronic device 700 with other devices to exchange data.

It is noteworthy that the electronic device 700 shown in FIG. 7 is merely an example and should not bring any limitation to the functionality and use scope of the embodiments of the present disclosure. Although FIG. 7 shows the electronic device 700 including various units, it would be appreciated that not all of the units as shown are required to be implemented or provided. Alternatively, more or fewer units may be implemented or provided.

In particular, according to embodiments of the present disclosure, the processes described above with reference to the flowcharts may be implemented as computer software programs. For example, embodiments of the present disclosure include a computer program product comprising a computer program carried on a non-transitory computer readable medium, the computer program containing program code for performing the methods as in the flowcharts. In those embodiments, the computer program may be downloaded and installed from a network via the communication unit 709, or may be installed from the storage unit 708, or may be installed from the ROM 702. The computer program, when executed by the processor 701, performs the above-described functions defined in the virtual resource processing method according to the embodiments of the present disclosure.

Embodiments of the present disclosure further provide a computer readable storage medium storing a computer program thereon. The computer program, when executed by a processor, causes the processor to implement the virtual resource processing method in any of the embodiments of the present disclosure.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to perform the steps of the virtual resource processing method as described in any of the embodiments of the present disclosure.

The electronic device may have computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

Above described are only optimal embodiments of the present disclosure and the technical principles applied therein. It would be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

I/We claim:

1. A method of processing virtual resources, comprising:
determining, in response to a target interaction operation on a character-related content in a book, an interaction result of the target interaction operation, wherein the character-related content comprises a character discussion content and/or a character-related plot in the book; and
allocating a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

2. The method of claim 1, wherein determining, in response to the target interaction operation on the character-related content in the book, the interaction result of the target interaction operation comprises:
determining, in response to a publishing operation on the character discussion content, a content quality value of the character discussion content; and
determining, in response to a reading operation on the book, a reading time length.

3. The method of claim 2, wherein allocating the character-type virtual resource to the user in the event that the interaction result satisfies the preset condition comprises:
in the event that the reading time length reaches a time length threshold and the content quality value reaches a quality threshold, allocating the character-type virtual resource of a corresponding character to the user based on the character discussion content.

4. The method of claim 1, wherein determining, in response to the target interaction operation on the character-related content in the book, the interaction result of the target interaction operation comprises:
determining, in response to an interaction operation on the character-related plot, a number of interactions of the interaction operation, wherein the interaction operation comprises at least one of a reading operation, a commenting operation, a tagging operation and a sharing operation.

5. The method of claim 1, further comprising:
determining, in response to an execution operation on a first task, a completion number of the first task, wherein the first task comprises at least one of a reading task of a preset number of chapters, a number of followers increased based on derivative content, a number of interactions gained based on the derivative content, and a number of reading conversions corresponding to the derivative content;
displaying a virtual resource extraction interface in the event that the completion number is greater than or equal to a preset number threshold, wherein an extraction control and a content to be extracted are displayed in the virtual resource extraction interface, and the content to be extracted contains at least one of the character-type virtual resources corresponding to the book; and
determining, in response to a triggering operation on the extraction control, a target extraction content from the content to be extracted based on the completion number, wherein a probability that the target extraction content is the character-type virtual resource of the character class is directly proportional to the completion number.

6. The method of claim 1, wherein a resource level of the character-type virtual resource is determined based on at least one of: a character definition in the book of a target character corresponding to the character-type virtual resource; whether the character-type virtual resource has a combination relationship with character-type virtual resources corresponding to other characters; character identity of the target character in the book; a number of book interactions of the user; and a number of booster users with whom the user has a social relationship,
wherein the number of book interactions comprises at least one of a reading time length of the book, a number of interactions on derivative content of the book, and a number of reading conversions corresponding to the derivative content published by the user.

7. The method of claim 1, wherein the method further comprises: after allocating the character-type virtual resource to the user in the event that the interaction result satisfies the preset condition:
determining a first opponent virtual resource in response to a battle triggering operation for the character-type virtual resource;
determining a battle result based on a resource level of the character-type virtual resource and a resource level of the first opponent virtual resource; and
allocating the character-type virtual resource and the first opponent virtual resource to a winning party in the battle result.

8. The method of claim 1, further comprising at least one of:
presenting, in a first page, a total number of the character-type virtual resources corresponding to the book;
presenting a first resource identifier of the character-type virtual resource in an information presenting area of the user in a second page; and
in the event that a cumulative number of the character-type virtual resources reaches a preset number or a character type of the character-type virtual resources reaches a preset type, converting the respective character-type virtual resources to a first preset resource.

9. The method of claim 1, further comprising:
determining, in response to an execution operation for a second task, a task metric value of the second task, wherein the second task comprises at least one of a reading-type task of the book, a production-type task of a derivative content corresponding to the book, and an interaction-type task based on the derivative content; and
in the event that the task metric value of any of the second tasks reaches a preset metric threshold, allocating a skill-type virtual resource corresponding to a task type of the second task to the user, wherein an attack value of the skill-type virtual resource is determined based on at least one of a reading time length of the book, a number of interactions of the derivative content, a number of reading conversions corresponding to the derivative content, a number of booster users with a social relationship, and an attack value is for battling with at least one other skill-type virtual resource corresponding to the same task type.

10. The method of claim 9, further comprising at least one of:
presenting a second resource identifier of the skill-type virtual resource of the user in a third page; and
additionally allocating a second preset resource to the user based on the number of wins of the user.

11. An electronic device, comprising:
a processor;
a memory for storing executable instructions;
wherein the processor is configured to read the executable instructions from the memory and execute the executable instructions to cause the electronic device to:
determine, in response to a target interaction operation on a character-related content in a book, an interaction result of the target interaction operation, wherein the character-related content comprises a character discussion content and/or a character-related plot in the book; and
allocate a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.

12. The electronic device of claim 11, wherein the instructions to determine, in response to the target interaction operation on the character-related content in the book, the interaction result of the target interaction operation comprise instructions to:
determine, in response to a publishing operation on the character discussion content, a content quality value of the character discussion content; and
determine, in response to a reading operation on the book, a reading time length.

13. The electronic device of claim 12, wherein the instructions to allocate the character-type virtual resource to the user in the event that the interaction result satisfies the preset condition comprise instructions to:
in the event that the reading time length reaches a time length threshold and the content quality value reaches a quality threshold, allocate the character-type virtual resource of a corresponding character to the user based on the character discussion content.

14. The electronic device of claim 11, wherein the instructions to determine, in response to the target interaction operation on the character-related content in the book, the interaction result of the target interaction operation comprise instructions to:
determine, in response to an interaction operation on the character-related plot, a number of interactions of the interaction operation, wherein the interaction operation comprises at least one of a reading operation, a commenting operation, a tagging operation and a sharing operation.

15. The electronic device of claim 11, wherein the instructions further comprise instructions to:
determine, in response to an execution operation on a first task, a completion number of the first task, wherein the first task comprises at least one of a reading task of a preset number of chapters, a number of followers increased based on derivative content, a number of interactions gained based on the derivative content, and a number of reading conversions corresponding to the derivative content;
display a virtual resource extraction interface in the event that the completion number is greater than or equal to a preset number threshold, wherein an extraction control and a content to be extracted are displayed in the virtual resource extraction interface, and the content to be extracted contains at least one of the character-type virtual resources corresponding to the book; and
determine, in response to a triggering operation on the extraction control, a target extraction content from the content to be extracted based on the completion number, wherein a probability that the target extraction content is the character-type virtual resource of the character class is directly proportional to the completion number.

16. The electronic device of claim 11, wherein a resource level of the character-type virtual resource is determined based on at least one of: a character definition in the book of a target character corresponding to the character-type virtual resource; whether the character-type virtual resource has a combination relationship with character-type virtual resources corresponding to other characters; character identity of the target character in the book; a number of book interactions of the user; and a number of booster users with whom the user has a social relationship,
wherein the number of book interactions comprises at least one of a reading time length of the book, a number of interactions on derivative content of the book, and a number of reading conversions corresponding to the derivative content published by the user.

17. The electronic device of claim 11, wherein the instructions further comprise instructions to: after allocating the character-type virtual resource to the user in the event that the interaction result satisfies the preset condition:
determine a first opponent virtual resource in response to a battle triggering operation for the character-type virtual resource;
determine a battle result based on a resource level of the character-type virtual resource and a resource level of the first opponent virtual resource; and
allocate the character-type virtual resource and the first opponent virtual resource to a winning party in the battle result.

18. The electronic device of claim 11, wherein the instructions further comprise instructions to perform at least one of:
present, in a first page, a total number of the character-type virtual resources corresponding to the book;
present a first resource identifier of the character-type virtual resource in an information presenting area of the user in a second page; and
in the event that a cumulative number of the character-type virtual resources reaches a preset number or a character type of the character-type virtual resources reaches a preset type, convert the respective character-type virtual resources to a first preset resource.

19. The electronic device of claim 11, wherein the instructions further comprise instructions to:
determine, in response to an execution operation for a second task, a task metric value of the second task, wherein the second task comprises at least one of a reading-type task of the book, a production-type task of a derivative content corresponding to the book, and an interaction-type task based on the derivative content; and
in the event that the task metric value of any of the second tasks reaches a preset metric threshold, allocate a skill-type virtual resource corresponding to a task type of the second task to the user, wherein an attack value of the skill-type virtual resource is determined based on at least one of a reading time length of the book, a number of interactions of the derivative content, a number of reading conversions corresponding to the derivative content, a number of booster users with a social relationship; and an attack value is for battling with at least one other skill-type virtual resource corresponding to the same task type.

20. A non-transitory computer readable storage medium, wherein the storage medium stores computer programs which, when executed by a processor, cause the processor to:
determine, in response to a target interaction operation on a character-related content in a book, an interaction result of the target interaction operation, wherein the character-related content comprises a character discussion content and/or a character-related plot in the book; and
allocate a character-type virtual resource to a user in the event that the interaction result satisfies a preset condition, wherein a relationship between a plurality of character-type virtual resources is determined based on a character relationship in the book, and wherein the character-type virtual resource is used for user interaction in a book community.
